(19) United States
(12) Patent Application Publication
(10) Pub. No.: US 2005/0222828 A1
(43) Pub. Date: Oct. 6, 2005

(54) Method for computing subjective dissimilarities among discrete entities

(76) Inventors: Ehtibar Dzhafarov, Lafayette, IN (US); Hans Colonius, Oldenburg (DE)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/097,585

(22) Filed: Apr. 1, 2005

Related U.S. Application Data
(60) Provisional application No. 60/559,307, filed on Apr. 2, 2004.

(51) Int. Cl. G06F 17/10

(52) U.S. Cl. 703/2

(57) ABSTRACT

A method for computing subjective dissimilarities among discrete entities is provided. The method includes the steps of presenting a plurality of entities to a perceiver, determining discrimination probabilities among the entities, and computing Fechnerian distances and the shortest pathways between the entities.

### CROSS-REFERENCE TO RELATED APPLICATIONS

This application claims the benefit of U.S. Provisional Patent Application Ser. No. 60/559,307 filed Apr. 2, 2004, the entirety of which is incorporated herein by this reference. This application is related to U.S. Provisional Patent Application Ser. No. 60/458,732 filed Mar. 28, 2003, the entirety of which is incorporated herein by this reference.

The present invention was developed with U.S. government support under grant reference number NSF SES-0318010. The U.S. government has certain rights in the invention.

### BACKGROUND

A technical paper “Purdue University Mathematical Psychology Program: Fechnerian Scaling of Discrete Object Sets” by Ehtibar N. Dzhafarov and Hans Colonius (Technical Report No. 04-1) is submitted herewith as Appendix A, the entirety of which is incorporated herein by this reference. A document entitled “Algorithm of FSDOS,” by Ehtibar Dzhafarov and Hans Colonius, is submitted herewith as Appendix B, the entirety of which is incorporated herein by this reference.

The present invention relates to the field of psychometrics. More particularly, the present invention relates to methods of computing dissimilarities among discrete entities. Such methods may be used, for example, to classify entities, cluster entities into groupings of similar items, or to discern the features or aspects of entities that are particularly relevant to a group of perceivers.

Known methods of computing dissimilarities among entities include multi-dimensional scaling (MDS) and Thurstonian scaling. MDS is based on restrictive assumptions about the process of discrimination and the mathematical structure of subjective dissimilarities. In its classical form, MDS requires that the perceivers be able to give numerical estimates of subjective dissimilarities, which is a much higher-order ability than the fundamental ability of telling entities apart from one another (or discriminating among entities). When dealing with probabilities of discrimination, MDS requires that the probabilities satisfy several constraints that are not, as a rule, satisfied in real data.

Thurstonian scaling is limited in that it applies only to one specific kind of discrimination probabilities: the probabilities with which one entity is judged to have more of a particular property (such as attractiveness, brightness, loudness, etc.) than another entity. The use of these probabilities therefore requires that the investigator know in advance which properties are relevant, that these properties be semantically one-dimensional (i.e., assessable in terms of greater-less), and that the perception of the entities be entirely determined by these properties. None of these assumptions (that may or may not be true depending on the application) are required to be made in the method of the present invention.

### SUMMARY

The present invention applies an original method, referred to by the inventors as Fechnerian Scaling of Discrete Object Sets (FSDOS), to compute subjective dissimilarities among various entities from the probabilities with which these entities are judged to be the same or different. For purposes of this disclosure, entities may be objects, people, commercial products, symbols, information, images, or other tangible or otherwise perceivable things.

The method of the present invention utilizes the capability of living organisms and artificial intelligence systems to react differently depending on whether two entities are the same or different. The discrimination probabilities and other data used by the method can be obtained by a variety of different procedures to suit a variety of application-specific needs.

Computations supporting the method of the present invention produce a network (i.e., a matrix or matrices) of values representing dissimilarities (distances) among the entities and the shortest pathways in the network leading from one entity to another. Unlike prior methods, these computations do not involve any preconceived constraints about the process of obtaining the discrimination judgments or about the mathematical structure of the dissimilarities. The method of the present invention may be easily implemented using computer programming, for example, as described herein.

The present invention has a broad range of potential applications in consumer research, advertising, polling, education, artificial intelligence systems development, academic, military and defense applications, and many others not specifically mentioned in this disclosure.

### BRIEF DESCRIPTION OF THE DRAWINGS

The above-mentioned and other aspects of the present invention are described in detail below, with reference to the accompanying drawings, in which:

FIG. 1 is a flow diagram illustrating the steps included in one embodiment of the present invention;

FIG. 2 is a schematic block diagram illustrating one embodiment of the method of the present invention;

FIG. 3 in a flow diagram illustrating steps performed by one embodiment of computer programming logic implementing the method of the present invention;

FIG. 4 is an exemplary matrix of discrimination probabilities Ψ (sᵢ, sⱼ);

FIG. 5 is a display screen of an exemplary computer program for implementing the method of the present invention;

FIG. 6 is an exemplary table of Fechnerian distances between entities computed by the illustrated software program;

FIG. 7 is an exemplary table of geodesic loops, the shortest paths leading from each entity to another and back, computed by the illustrated software program; and

FIG. 8 is an exemplary graphical display of Fechnerian distances, generated by the illustrated software program.

The examples described herein illustrate various aspects of the present invention, in several forms. However, the particular embodiments, variations, and applications disclosed herein are not intended to be exhaustive or to be construed as limiting the scope of the invention to the precise forms disclosed.

### DETAILED DESCRIPTION

The presently disclosed method, referred to by the inventors as Fechnerian Scaling of Discrete Object Sets (FSDOS), computes subjective dissimilarities among various entities from their discrimination probabilities.

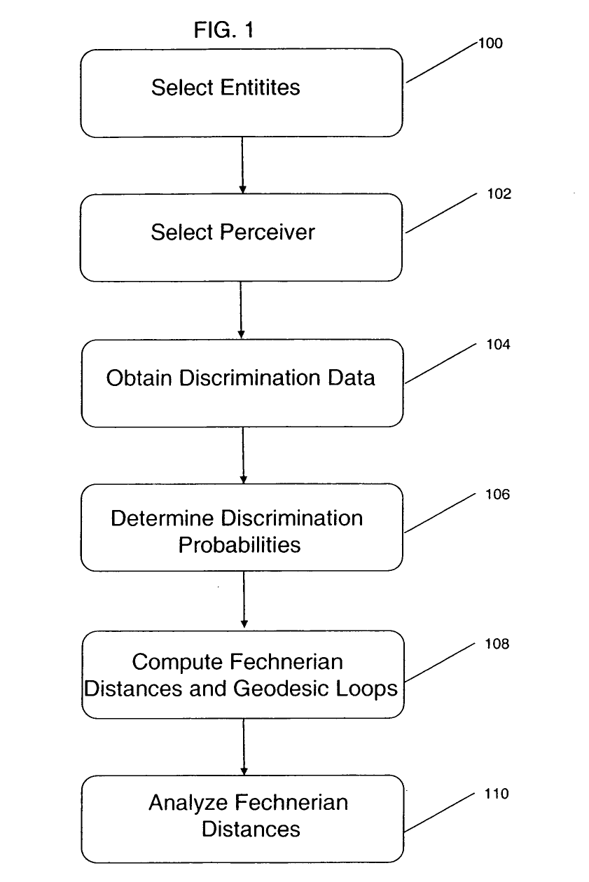

For purposes of this disclosure, a “discrimination probability” is the probability that an entity is judged to be different from another entity; the term “perceiver” indicates a person, organism, a group of people or organisms, or a technical/computational system; and the term “subjective dissimilarity” means that the degree of dissimilarity among entities is determined from the point of view of a perceiver. Referring now to FIG. 1, the illustrated embodiment of the present invention includes steps 100, 102, 104, 106, 108 and 110.

At step 100, the particular discrete entities to be considered are selected or defined. In this disclosure, such entities may be referred to as S₁, S₂, . . . S_{N}. As noted above, examples of entities include symbols, pictures, products, persons, data, images, patterns of information, and other tangible or otherwise perceivable items.

The entities whose subjective dissimilarities are to be determined may be any type of discrete entities. For example, if the perceiver is a group of grammar school children, the entities to be compared by them may be the numbers 1-9 or the letters of the alphabet. If the perceiver is a physician, the entities to be evaluated by her or him might be X-ray films representing different physiological dysfunctions. If the perceiving system includes a radar system or radar operators, the entities to be considered by the perceiving system could include different weapons systems or military formations. If the perceiver is a group of consumers, the entities to be presented to them may be different brands of a certain product. If the perceiver is a group of potential voters, the entities to be evaluated could be political candidates or positions taken on social, economic, business, political, or other issues. The sphere of potential applications of the present method and system is virtually limitless.

At step 102, a perceiver is selected or defined. A perceiver or perceiving system is a person, device, application (such as an artificial intelligence system), or robotic system, animal or other organism; or a group or population of such persons, devices, applications, animals or other organisms. The perceiver provides the data from which discrimination probabilities are discerned for each of the entities s₁ . . . s_{N}. The perceiver is selected or defined according to the particular application of the method. For example, in certain applications, a perceiving system may include voters from one or more geographic localities, consumers having one or more income levels, or students from one or more school districts. In other applications, a perceiver may be a neuronal structure or a technical device, such as an electronic sensor. The term “perceiver” is used herein for ease of reference, however, it is understood that as used herein, this term includes the singular and plural forms.

At step 104, discrimination data for the entities is obtained from the perceiver. While certain of the illustrated examples assume that the perceiver visually perceives the entities, other means of perceiving or sensing the entities may also be used, including sensing using hearing, smell, touch or taste abilities. Also, as mentioned above, the perceiver may be an apparatus with perceiving or sensing capabilities or even a computational procedure or computerized system whose inputs are entered by an operator.

The raw discrimination data may be obtained in a variety of ways. For example, if children are the perceivers and the entities to be discriminated are numbers or letters, the children may be asked to identify the letter or number being shown or displayed, or to indicate whether they think that the two letters being shown or displayed are the same or different. Using consumers as perceivers, consumers may be asked whether it would make a difference to them if a product A in their shopping cart was replaced with a product B. Or, consumers may be asked to rank-order products A, B, C and D from most similar to least similar.

To obtain the raw discrimination data from the perceiver, the entities are presented in any of a variety of suitable means of presentation. For example, in the illustrated embodiments, the entities are grouped into pairs and presented to the perceiver in pairs. In other embodiments, the entities are presented to the perceiver one at a time.

Also, the method of questioning the perceiver may be selected as appropriate for the specific application. In the illustrated embodiment, direct questioning is used. In direct questioning, the perceiver is typically asked whether the entities presented to them are the same or different, with or without respect to a certain characteristic or purpose. In other embodiments, semi-direct questioning is used. In semi-direct questioning, the perceiver is typically asked to name or otherwise identify the entity. In still other embodiments, indirect questioning is used. In indirect questioning, the perceiver is typically asked to classify the entities into groupings or categories, or rank-order the entities according to a characteristic attribute.

In all cases, the perceivers may be polled or queried orally (for example, by face-to-face interviewing), electronically using a computing device, questionnaire, or by other similar suitable polling, questioning, querying, or surveying means. In addition, the perceivers'responses may be in the form of written, oral, or electronic responses or signals, physical gestures, or other types of discernible indications.

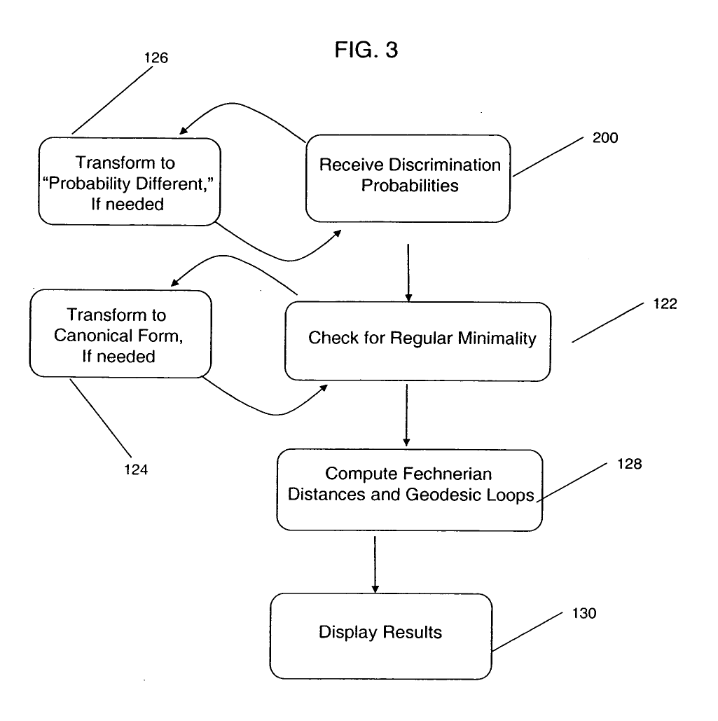

At step 106, once all of the perceiver's responses or indications have been obtained, a percentage representing the number of times each particular response occurs is determined for each particular entity or pair of entities. For example, if the perceiver is a single person, each pair of entities can be presented many times and the percentage of times the person replied “different” be recorded. If the perceiver is a group of people, one can record the percentage of people in the group who responded “different.” These percentages are then converted into probabilities of discrimination. An N×N matrix (where N is the total number of entities being considered), Ψ(sᵢ, sⱼ) (where i is the matrix row and j is the matrix column) is then created. In the illustrated embodiment, the probabilities in the matrix Ψ(sᵢ, sⱼ) are the probabilities that the entities sᵢ, sⱼ are judged to be different. In other embodiments, the probabilities that the entities sᵢ, sⱼ are the same are used, and the method is adapted accordingly. An example of a discrimination probabilities matrix is shown in FIG. 3, described below.

At step 108, using the discrimination probabilities computed in step 106, a network of dissimilarities is created by computing the Fechnerian distances between the entities as described below. This network may then be used to group the entities into distinct clusters of similar things and/or to determine significant subjective features of these entities.

The network of dissimilarities is created as follows. First, the matrix Ψ (sᵢ, sⱼ) is checked for the property the inventors call “regular minimality,” i.e., if the cell (i,j) contains the smallest value in the ith row, then the same cell should also contain the smallest value in the jth column. In embodiments where the matrix Ψ(sᵢ, sⱼ) contains probabilities that the entities sᵢ, sⱼ are the same, the matrix Ψ(sᵢ, sⱼ) is instead checked for regular maximality (i.e., the largest cell in its row is also the largest in its column), or the probabilities in matrix Ψ(sᵢ, sⱼ) are converted to probabilities that the entities are different, i.e., by subtracting the matrix values from 1.

The row object sᵢ and the column object sⱼ are referred to as points of subjective equality (PSEs) for one another if Ψ(sᵢ, sⱼ) is the smallest probability in the ith row and the jth column.

Once regular minimality (or regular maximality, as the case may be) is established, a table of mutual PSEs [(s₁, sⱼ₁), (s₂, sⱼ₂), . . . (sₙ, sⱼₙ)] is created wherein (j₁, j₂ . . . jₙ) is a complete permutation of (1, 2, . . . N). In the illustrated embodiment, the matrix objects (sᵢ, sⱼ) are relabeled by assigning the same symbol (otherwise arbitrary) to each pair of mutual PSEs, for example: (s₁, sⱼ₁)→(s₁, s₁), (s₂, sⱼ₂)→(s₂, s₂), . . . , (s_{N}, s_{jN})→(s_{N}, s_{N}). An intermediate matrix {S₁, S₂, . . . , S_{N}}×{S₁, S₂ . . . S_{N}} is then formed, with PSEs comprising the main diagonal. In the inventors' terminology, regular minimality in this matrix is satisfied in a canonical form. Denoting Ψ (Sᵢ, Sⱼ)=pᵢⱼ (i, j,=1, . . . , N), psychometric increments are computed for each of the matrix elements: Φ⁽¹⁾(Sᵢ, Sⱼ)=pᵢⱼ−pᵢᵢ.

For every chain of elements Sᵢ=x₁, x₂ . . . xₖ=Sⱼ (starting at Sᵢ, ending at Sⱼ, and including zero, one, or more other elements from the set Sᵢ, S₂, . . . , S_{N}), one computes the psychometric length of this chain as L⁽¹⁾ (x₁, x₂, . . . , xₖ)=Σ^{k-1} _{m=1 Φ}⁽¹⁾(xₘ, xₘ₊₁). A chain with the shortest psychometric length connecting Sᵢ to Sⱼ is called a geodesic chain, and its psychometric length is referred to by the inventors as the oriented Fechnerian distance G₁ (Sᵢ, Sⱼ).

Next, the overall Fechnerian distances Gᵢⱼ=G₁ (Sᵢ, Sⱼ)+G₁ (Sⱼ, Sᵢ)=Gⱼᵢ are computed from the N×N matrix G₁ (sᵢ, sⱼ). The geodesic chain from Sᵢto Sⱼ is concatenated with that from Sⱼ to Sⱼ to form a geodesic loop between Sᵢand Sⱼ whose length L⁽¹⁾ equals Gⱼᵢ.

The above steps and their theoretical underpinnings are described in more detail in the attached Appendices, which are incorporated herein by this reference.

At step 110, the computed Fechnerian distances may be further analyzed using known techniques as may be desirable for a particular application. For example, multidimensional scaling techniques and/or cluster analyses may be performed on the network of Fechnerian distances computed as described above.

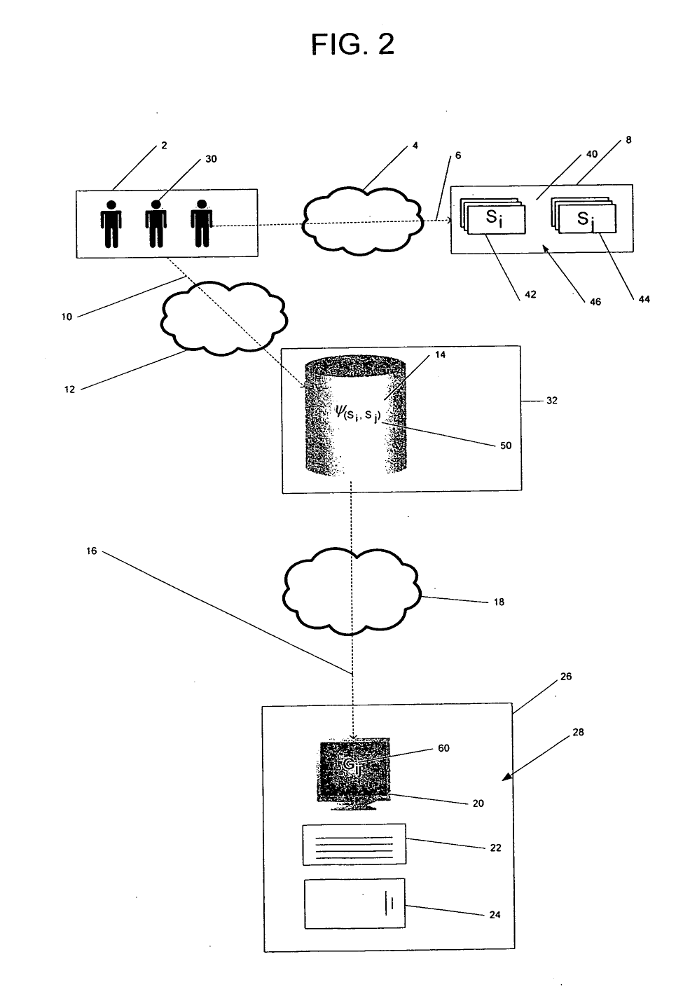

FIG. 2 illustrates an exemplary system for implementing the method of the present invention. In FIG. 2, there is shown a perceiver 30, a plurality of entities 40, a data storage or memory 14, and a computer or computing device 28.

Perceiver 30 is physically located at one or more locations 2, entities 40 are located at one or more locations 8, memory 14 is located at one or more locations 32, and computing device 28 is located at one or more locations 26. Locations 2, 8, 32 and 26 may be the same location, or different locations.

Memory 14 is operatively coupled to computing device 28 either directly, or, as shown in FIG. 2, via a network 18 by a network connection 16.

Perceiver 30 perceives entities 40 either directly or via a network 4 by a network connection 6. As noted above, such perceiving by perceiver 30 may be accomplished by sight, sound, touch, taste, smell or otherwise.

In the illustrated embodiment, entities 40 or images thereof are presented to the perceiver in pairs 46 which each include a first entity 42 and second entity 44.

Perceivers 30 provide indications of whether entities 42, 44 are similar or different from each other. Such indications are recorded and stored in memory 14. In the illustrated embodiment, perceiver 30 transmits such indications to memory 14 via a network 12 by a network connection 10. Networks 4, 12, and 18 may be the same or different networks. Networks 4, 12, and 18 may be electronic, cable, telephone, DSL, wireless or other suitable network for data communication.

Computing device 28 illustratively includes a display device 20, an input device 22 and a processor 24. Computing device 28 executes programming logic to access the indications data (“raw discrimination data”) stored in memory 14, convert the discrimination data to probability matrix Ψ(sᵢ, sⱼ), and process the probability matrix Ψ(sᵢ, sⱼ) performing computations to generate and display the Fechnerian distances Gᵢⱼ and/or graphical representations thereof.

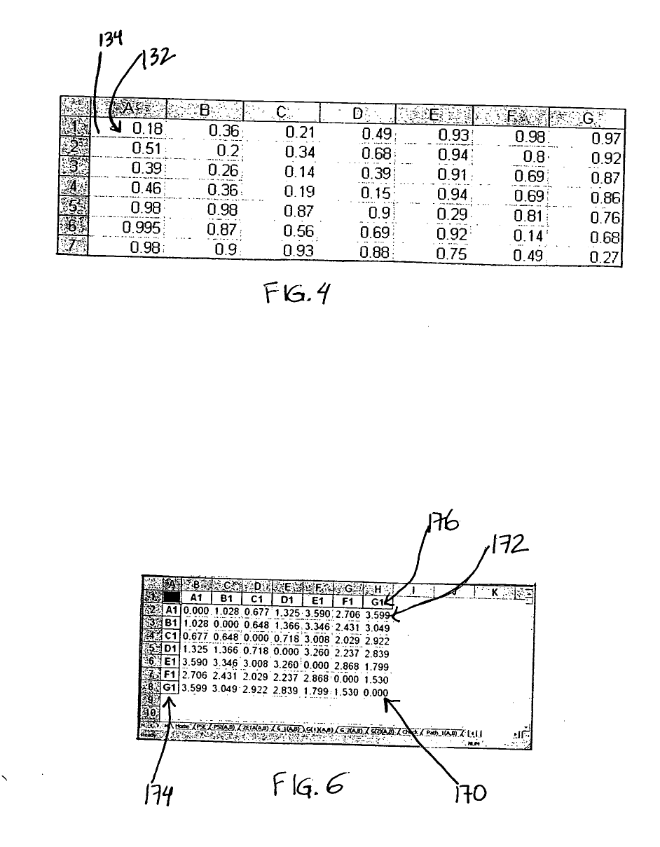

FIG. 3 is a flow diagram illustrating steps performed by one embodiment of computer programming logic to implement the method of the present invention. At step 120, data representing the probabilities of dissimilarity, i.e. the elements of the matrix Ψ(sᵢ, sⱼ), among the entities is received into memory 14. Such data may be transmitted electronically (i.e., over a network) or input using an input device 22. In the illustrated embodiment, the matrix Ψ (sᵢ, sⱼ) is stored in a Microsoft Excel file which is accessed by the computer program. FIG. 4 shows one example of such a file. Labeling of the entities, if necessary, is automatically performed by the computer program.

At step 122, the computer program data representing the probabilities of dissimilarity checks for either regular minimality or regular maximality, as the case may be. In the example of FIG. 4, the data represents the probability that the entities are different, therefore, the data is checked for regular minimality. Step 126, which is optional, is performed if the data representing the probabilities of dissimilarity corresponds to the probability that the entities are the same. Computer programming login is used to transform the data to “Probability Different” format using the equation (100−X/100) where X is the data element. Additional transform5ations may b performed on the data as may be desired for a particular application, for example, log (X/(1−X)).

At step 124, the matrix Ψ(sᵢ, sⱼ) is converted to a canonical form, as described above and in the Appendices.

At step 128, the Fechnerian distances between entities, based on the probabilities of dissimilarity, and geodesic loops, are computed. All of the Fechnerian computations, as described above and in the Appendices, are executed by computer programming logic. If regular minimality (or maximality) was violated in the data, then the computations will stop and an indication of the error will be presented in the form of an alert (audio, visual, or otherwise) to the user.

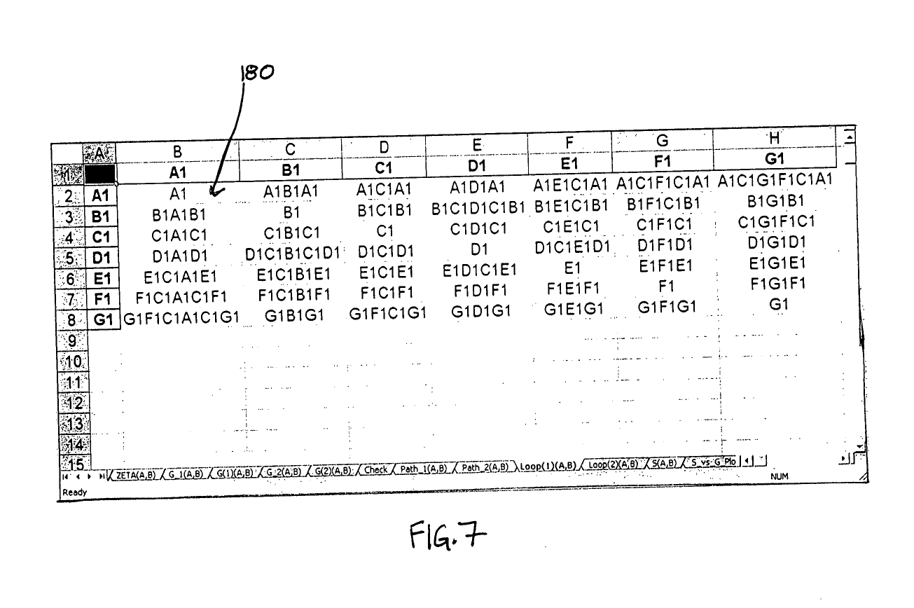

FIG. 6 shows an exemplary matrix of Fechnerian distances computed from the sample input matrix Ψ(sᵢ, sⱼ) of FIG. 4. Regular minimality is satisfied in this example.

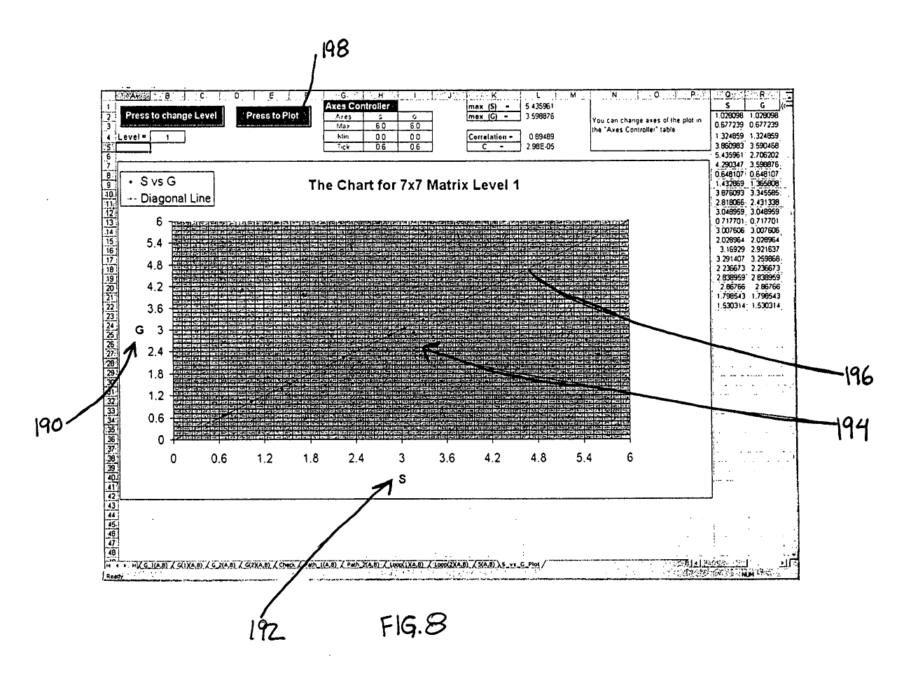

At step 130 of FIG. 3, the results of the computations are provided. In the illustrated embodiment, the results are displayed on a display device 20. In other embodiments, the results may be, alternatively or in addition, transmitted to a remote location, such as a client computing device, PDA, or other similar device. Also, the results may be displayed in textual or graphical form. FIG. 7 shows an example of a display in textual form, while FIG. 8 shows an example of a display of results in graphical form.

FIGS. 4-8 are exemplary screen displays for a computerized implementation of the method of the present invention. FIG. 4 illustrates a matrix of discrimination probabilities Ψ(sᵢ, sⱼ) wherein each matrix element represents the probability that one entity is different from another. Note that the values along the matrix diagonal are not necessarily zero and are not necessarily equal to each other. This is due to the fact that the dissimilarities are based on subjective interpretations. In the illustrated embodiment, the matrix Ψ(sᵢ, sⱼ) is created and stored using a commercially available spreadsheet program such as Microsoft Excel. However, it is understood that other suitable software for storing data (such as database software) may also be used.

As noted above, FIG. 4 illustrates an exemplary matrix of discrimination data Ψ(sᵢ, sⱼ). The value 132 in each of the cells 134 represents the subjective probability (as determined by the perceivers) that the row objects sᵢ is different than the column object sⱼ. For example, according to this exemplary matrix, the probability that the entity labeled 1A (row object) is different than the entity labeled A1 (column object) is 0.18. Of course, since the entity 1A is the same as the entity A1, this value would be zero in an objective world.

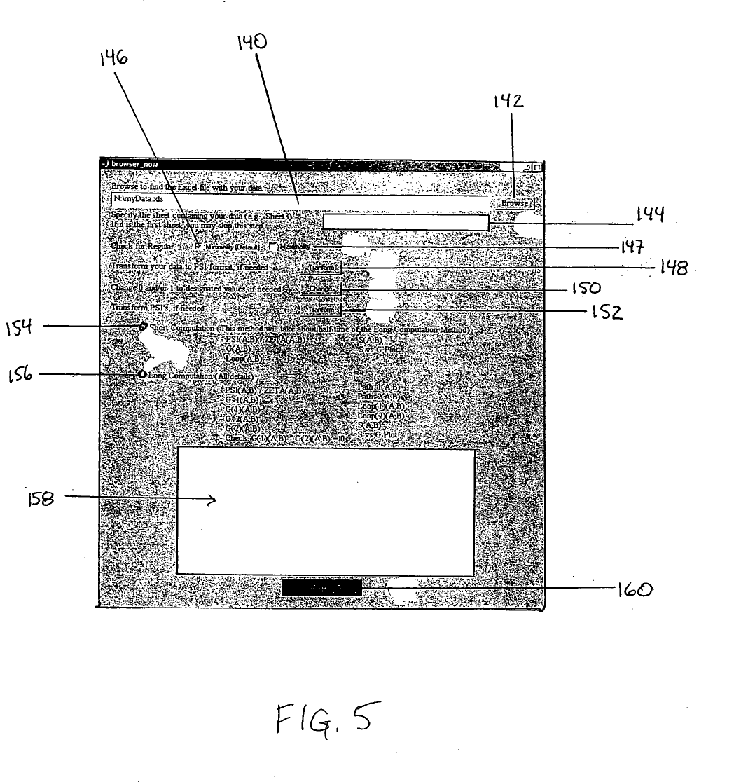

FIG. 5 represents an illustrative user input screen for a computer program designed to implement the method of the present invention. Input areas 140 and 144, and browse button 142 are provided to enable a user to define to the computer program the location of the discrimination data Ψ(sᵢ, sⱼ). In the illustrated example, the location is an Excel spreadsheet file.

Check boxes 146, 147 are provided to enable a user to indicate whether the matrix Ψ(sᵢ, sⱼ) is “Probability Different” or “Probability Same” (this requiring a check for a regular minimality or maximality as the case may be). Either one of boxes 146, 147 may be selected. Button 148, if selected, causes the necessary calculations to be performed to transform the data to “Probability Different’ format, as described above.

Buttons 150 and 152 may be selected to perform additional transformative operations on the discrimination data, if desired, as described above.

Radio buttons 154, 156 represent two options for computing the Fechnerian distances. The long computation, which is performed if button 156 is selected, displays all of the intermediate results of the computation. When the user is satisfied with all of the criteria entered above, he or she may actuate button 160 to begin the computations. A window 158 may be provided to, for example, display the status and/or intermediate steps performed in the computations.

Results of the computations are displayed, illustratively in spreadsheets such as shown in FIGS. 6, 7, and 8. FIG. 6 is a display of the overall Fechnerian distances 172 between the entities [G (A,B)]. Row and column labels (174, 176, respectively) are provided. Consistent with regular minimality and the definition of a distance, the values are zero along the diagonal 170.

FIG. 7 depicts Loop (A,B), which is a geodesic loop containing both entities A and B. The values 180 in the matrix Loop (A,B) represent the path corresponding to the Fechnerian distances contained in the matrix G(A,B). In other words, the geodesic loop (A,B) is the shortest path from the row entity A to the column entity B and back again. For example, the contents of cell (A1, A1) represents the shortest path from entity Al to itself (representing the comparison of A1 to itself). Of course, this loop is A1, and its length is zero. As another example, the cell (G1,A1) shows that the shortest path from G1 to A1 and back is G1-F1-C1-A1-C1-G1; and its length G(G1,A1) is 3.599, as shown in FIG. 6. In general, it is not necessarily the case that a larger value of the Fechnerian distance (FIG. 6) results in a geodesic loop with more components (FIG. 7).

FIG. 8 is one example of a graphical representation of the results of the computations described above. FIG. 8 is a plot of the overall Fechnerian distance between A and B [G(A,B)] 190 versus the generalized “Shepardian” dissimilarity [S(A,B)] 192 described in the Appendix. The “Shepardian” dissimilarity S(A,B) is computed as ζ(A,2)+ζ(B,A)−ζ(A,A)−ζ(B,B) where ζ(A,B) is the transformed version of Ψ(A,B) (if either of the buttons 150, 152 were selected). The resulting values 194 are plotted on the graph with the linear relationship shown by diagonal 196. Button 198, if selected, executes programming logic to generate the plot.

In the illustrated embodiment, the method of the present invention is implemented on a computer using MATLAB, VISUAL BASIC, and MICROSOFT OFFICE commercially available software. However, it is understood that all of these components are not necessarily required in order to execute the program, and that other comparable software products could work equally as well.

The present invention has been described with reference to certain exemplary embodiments, variations, and applications. However, it is understood that the present invention is defined by the appended claims. It may be modified within the spirit and scope of this disclosure. This disclosure is therefore intended to cover any and all variations, uses, or adaptations of the present invention using its general principles.

1. A method of computing subjective dissimilarities among discrete entities, the method comprising the steps of:
presenting a plurality of discrete entities to a perceiver,
receiving from the perceiver an indication as to whether the entities are the same or different,
determining a discrimination probability for each pair of entities based on the indication received from the perceiver,
computing Fechnerian distances between the entities based on the discrimination probabilities,
computing geodesic loop for all pairs of entities, and
analyzing the Fechnerian distances to determine subjective dissimilarities among the entities.

2. The method of claim 1, wherein the perceiver is one of a person, and a biological organism.

3. The method of claim 1, wherein the perceiver is one of a device and a computational procedure.

4. The method of claim 1, wherein the presenting step includes transmitting a characteristic of the entities over a network.

5. The method of claim 1, wherein the computing step includes the steps of computing the overall distance between the entities in each pair of entities and the shortest pathways leading from one entity to another and back.

6. A method for computing subjective dissimilarities among discrete objects, the method comprising the steps of:
receiving discrimination data for a plurality of discrete objects,
computing a first matrix of discrimination probabilities for the selected objects,
checking the first matrix for one of regular minimality and regular maximality,
identifying a point of subjective equality for each row and column in the first matrix,
computing a second matrix of psychometric increments for each pair of objects,
computing the shortest pathways leading from one entity to another and back, and
identifying the distance between objects for each pair of objects as the length of the geodesic pathways.

7. The method of claim 6, further comprising the step of generating the discrimination data by querying at least one perceiver.

8. The method of claim 6, wherein the discrimination probabilities are probabilities that the objects are different.

9. The method of claim 6, further comprising the step of assigning a label to each object.

10. The method of claim 6, wherein the points of subjective equality are identified by comparing row objects and column objects of the first matrix and identical labels are assigned to objects which are each other's points of subjective equality.

11. The method of claim 6, wherein the psychometric increments are computed according to the equation Φ(Sᵢ, Sⱼ)=pᵢⱼ−pᵢᵢ.

12. The method of claim 6, wherein the length of a chain x₁, x₂, . . . , xₖ is computed according to the formula L(x₁, x₂, . . . , xₖ)=Σ^{k-1}ₘ₌₁ Φ(xₘ, xₘ₊₁).

13. The method of claim 6, wherein the minimum distances are computed according to the equation Lₘᵢₙ(Sᵢ, Sⱼ)=the smallest L(x₁, x₂, . . . , xₖ) across all chains x₁, x₂, . . . , xₖ with x₁=Sᵢ and xₖ=Sⱼ.

14. The method of claim 6, further comprising the step of generating a geodesic loop for each pair of objects.

15. A system for computing subjective dissimilarities among discrete objects, the system comprising:
an input device,
a processor adapted to:
receive data representing discrimination probabilities for a plurality of objects, and
compute Fechnerian distances between the objects using the data representing discrimination probabilities, and
a display operatively coupled to the processor to graphically depict the Fechnerian distances between the objects.

16. The system of claim 15, further comprising a communication network, wherein the input device is operatively coupled to the processor via the communication network.

17. The system of claim 15, wherein the input device and the display are included in a remote device, and the remote device is operatively coupled to the processor by a communication network.

18. The system of claim 15, wherein the processor is further adapted to check for regular minimality of the discrimination data.

19. The system of claim 15, wherein the processor is further adapted to generate geodesic loops for each pair of objects.
